(19) United States
(12) Patent Application Publication
(10) Pub. No.: US 2018/0349850 A1
(43) Pub. Date: Dec. 6, 2018

(54) Transport Plan Generating Method and Transport Plan Generating System

(71) Applicant: Hitachi, Ltd., Tokyo (JP)

(72) Inventors: Junko HOSODA, Tokyo (JP); Futoshi KOIKE, Tokyo (JP)

(21) Appl. No.: 15/909,403

(22) Filed: Mar. 1, 2018

(30) Foreign Application Priority Data
May 30, 2017 (JP) 2017-106602

(51) Int. Cl. G06Q 10/08

(52) U.S. Cl. CPC G06Q 10/08355; G06Q 10/087

(57) ABSTRACT

A transport planning system that performs efficiently a delivery without lowering a load factor of each vehicle is provided. The invention is directed to a transport plan generating method using an information processing apparatus including an input device, a processor, and an output device. The method is characterized by generating a delivery route of a commodity by a delivery unit from a forwarding source to a forwarding destination; assuming a moving warehouse that is temporarily installed and movable when there are the plurality of forwarding sources; changing the delivery route so that the commodity is delivered to the forwarding destination via the moving warehouse; and generating a movement instruction with respect to the delivery unit and the moving warehouse so as to realize the changed delivery route.

### TECHNICAL FIELD

The present invention relates to a technique for generating a transport plan using an information processing apparatus.

### BACKGROUND ART

As a background art in this technical field, there is disclosed in JP-A-2013-133198 (PTL 1). This publication discloses that “a vehicle operation plan can be efficiently created in regards to a delivery planning problem including loads having a plurality of specified times” (see Abstract).

### CITATION LIST

### Patent Literature

PTL 1: JP-A-2013-133198

### SUMMARY OF INVENTION

### Technical Problem

A structure is disclosed in PTL 1 in which commodities to be transported from a specified warehouse are allocated to vehicles such that the number of vehicles reduced. In the structure disclosed in PTL 1, the warehouse, from which the commodities are transported, is fixed, and the commodities transport once are delivered to a delivery destination without stagnation.

However, even when it is desirable to transport the commodities from a warehouse close to the delivery destination or a warehouse where a delivery vehicle exists nearby, from the viewpoint of delivery efficiency, there is a possibility that the delivery efficiency is lowered in a case where the commodities should be transported from a warehouse determined in advance. In addition, when the commodities transported from a plurality of warehouses are delivered to one delivery destination, the commodities are delivered from the respective warehouses by individual vehicles, and there is concern that the delivery efficiency of each vehicle decreases. Therefore, a transport planning system is preferred which efficiently performs the delivery without lowering a load factor of each vehicle.

### Solution to Problem

One aspect of the invention provides a transport plan generating method using an information processing apparatus including an input device, a processor, and an output device. In the method, from the input device, the information processing apparatus is capable of acquiring “order information including a customer address that specifies a position of a transport destination and a commodity name that specifies a commodity to be transported”, “vehicle information including a vehicle name that specifies a vehicle and current address information that specifies a current address of the vehicle”, “warehouse information including a warehouse name that specifies a warehouse, in which the commodity is stored, and warehouse address information that specifies a current address of the warehouse”, “inventory information including information on the commodity stored in the warehouse corresponding to the warehouse name”, and “temporary-warehouse installation candidate information including information on a candidate site where there is a possibility that a movable temporary warehouse is disposed among the warehouses”. The input device may be a communication device connected to a network, and may be an input unit to a storage device.

The processor executes, by software or hardware, processes of receiving the order information, receiving the vehicle information, and receiving the warehouse information and the inventory information. Then, the processor executes a process of generating a first transport plan including plans to specify the warehouse as a commodity transport source and a vehicle transporting the commodity, based on the order information, the vehicle information, the warehouse information, and the inventory information, to set at least one selected from the candidate sites as gathering area, and to transport the commodity from the transport source to the gathering area with the vehicle transporting the commodity. Then, an instruction based on the first transport plan to at least one of the vehicle and the temporary warehouse is issued from the output device.

Another aspect of the invention provides a system including an information processing apparatus which is capable of using “order information including transport destination position information that specifies a position of a transport destination and object information that specifies an object to be transported”, “transport unit information including transport unit identification information that specifies a transport unit and current transport unit position information that specifies a current position of the transport unit”, “stationary warehouse information including stationary warehouse identification information that specifies a stationary warehouse which does not move and stores the object and stationary warehouse position information that specifies a position of the stationary warehouse”, “inventory information including information on the object stored in the stationary warehouse corresponding to the stationary warehouse identification information”, “temporary warehouse information including temporary warehouse identification information that specifies a temporary warehouse which is movable and stores the object and temporary warehouse position information that specifies a position of the temporary warehouse” and “temporary-warehouse installation candidate information that specifies a position of a candidate site in which the temporary warehouse is settable up”. The information may be stored in the storage device, and may be obtained from another information processing apparatus using a communication line as appropriate.

The system includes a transport plan generating unit that generates a first transport plan, based on the order information, the transport unit information, the stationary warehouse information, the inventory information, the temporary warehouse information, and the temporary-warehouse installation candidate information, and the first transport plan is to transport the object from transport sources, which are a plurality of stationary warehouses selected from the stationary warehouses, to the transport destination via at least one of the candidate sites.

In a more specific example, the first transport plan includes a temporary warehouse setting-up plan to move at least one temporary warehouse selected from the temporary warehouses to at least one of the candidate sites.

A further another aspect the invention provides a transport plan generating method using an information processing apparatus including an input device, a processor, and an output device. The method is characterized by including: generating a delivery route of a commodity by a delivery unit from a forwarding source to forwarding destination; assuming a moving warehouse that is temporarily installed and movable when there are the plurality of forwarding sources; changing the delivery route so that the commodity is delivered to the forwarding destination via the moving warehouse; and generating a movement instruction with respect to the delivery unit and the moving warehouse so as to realize the changed delivery route.

### Advantageous Effects of Invention

The invention can provide a transport planning system that performs an efficient delivery without lowering a load factor of each vehicle.

### BRIEF DESCRIPTION OF DRAWINGS

FIG. 1 is a block diagram of a transport planning system according to an embodiment.

FIG. 2 is a diagram illustrating a hardware configuration of the transport planning system according to the embodiment.

FIG. 3 is a flowchart illustrating an example of a transport plan making process flow according to the embodiment.

FIG. 4 is a table illustrating an example of order information.

FIG. 5a is a table illustrating an example of vehicle information.

FIG. 6 is a table illustrating an example of warehouse information.

FIG. 7 is a table illustrating an example of inventory information.

FIG. 8 is a table illustrating an example of temporary-warehouse installation candidate information.

FIG. 9 is a flowchart illustrating an example of a transport route determining process flow according to the embodiment.

FIG. 10A is a conceptual diagram illustrating an example of a transport plan in a case where a temporary warehouse is not used.

FIG. 10B is a conceptual diagram illustrating an example of a transport plan in a case where a temporary warehouse is used.

FIG. 11 is a table illustrating an example of transport plan information.

FIG. 12 is a schematic diagram illustrating a transport plan output screen.

FIG. 13 is a table illustrating an example of temporary-warehouse operation instruction information.

FIG. 14 is a block diagram of transport plan measures according to a second embodiment.

FIG. 15 is a table illustrating an example of order-receiving prediction information according to the second embodiment.

FIG. 16 is a block diagram illustrating an example of a transport planning system according to a third embodiment.

FIG. 17 is a flowchart illustrating a processing example of the transport planning system according to the third embodiment.

### DESCRIPTION OF EMBODIMENTS

Hereinafter, embodiments will be described with reference to the drawings. However, the invention is not construed as being limited to the description of the embodiments described below. Those skilled in the art can easily understand that specific configurations can be changed without departing from the spirit or gist of the invention.

In a configuration of the invention described below, the same reference numerals are used for the same parts or parts having similar functions in different drawings, and a repeated description may be omitted.

When there are a plurality of elements having the same or similar functions, the same reference numerals may be given with different subscripts for description in some cases. However, when there is no need to distinguish between multiple elements, subscripts may be omitted for description in some cares.

The terms “first”, “second”, “third” and the like in this description and the like are given to identify the constituent features but do not necessarily limit the numbers, the orders, or the contents. Also, the numbers for identifying the constituent features are used independently in each context, and a number used in a context does not always indicate the same structure in another context. Moreover, a constituent feature identified by a number should not be prevented from also having the function of a constituent feature identified by another number.

In an example of a technique described in embodiments, there is to provide a transport planning system which, in consideration of the inventory quantity stored in the warehouse or the position and the loading situation of the vehicle, determines a warehouse from which commodities are transported and calculates a transport route including a temporary warehouse which temporarily stores and aggregates the commodities transported from a plurality of warehouses. Since the temporary warehouse is assumed as a movable vehicle, thereafter, it may be called a moving warehouse with attention paid to its function.

In an example of the technique described in embodiments, the transport planning system includes: a storage unit that collects the type and the inventory quantity of commodities in the warehouse, a traveling position of the vehicle, the loading amount, and the future travel schedule and accepts the customer's order; a transport plan generating unit that allocates the accepted customer's order to currently traveling and non-traveling vehicles and assumes a position of a temporary warehouse, which moves to the designated place and stores the commodities, to calculate a transport route through which the commodities are delivered from the warehouse to a delivery destination via the temporary warehouse; and a display unit that displays the calculated transport plan.

### First Embodiment

### [1. Functional Configuration of System]

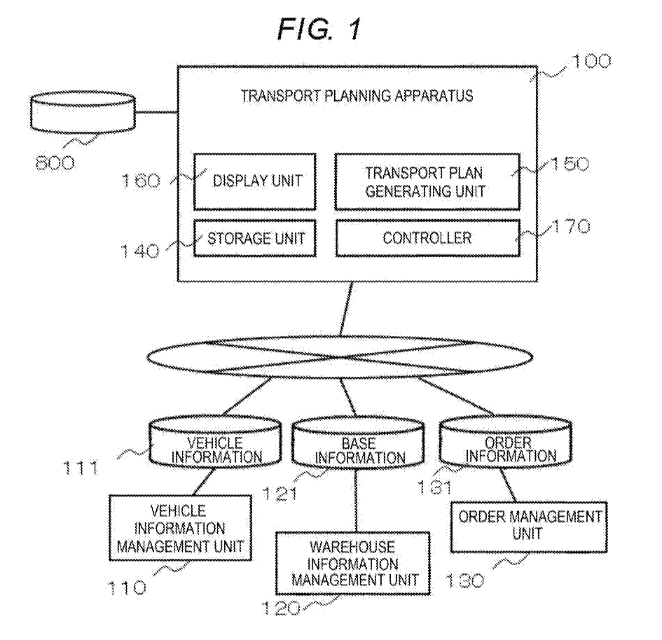

FIG. 1 is an example of a block diagram illustrating a functional configuration of a transport planning system according to a first embodiment. The transport planning system includes a transport planning apparatus 100, a vehicle information management unit 110, a warehouse information management unit 120, and an order management unit 130. The transport planning apparatus 100 includes a storage unit 140, transport plan generating unit 150, a display unit 160, and a controller 170, and makes it possible to use temporary-warehouse installation candidate information 800. The components can communicate with each other via a network 500.

The vehicle information management unit 110 is mounted on a vehicle that delivers commodities and collects vehicle information 111 and transmits the collected information to the transport planning apparatus 100. Further, the vehicle information management unit receives vehicle operation instruction information transmitted from the controller 170 and moves the vehicle according to the received instruction. The vehicle information 111 stored in a storage device provided in the vehicle or a server that is connected to the vehicle via a network and stores the vehicle information 111 transmitted from the vehicle. When the vehicle information 111 is stored in the storage device provided in the vehicle, information in a necessary range of a host vehicle, for example, information in a necessary range such as information on the host vehicle and vehicles around the host vehicle may be stored.

The warehouse information management unit 120 is installed in a warehouse or a temporary warehouse to collect base information 121 and transmit the collected information to the transport planning apparatus 100. Further, the temporary warehouse receives temporary-warehouse operation instruction information transmitted from the controller 170, and the temporary warehouse moves according to the instruction. The temporary warehouse is a warehouse having a moving function and has a function similar to that of the warehouse for a predetermined period, but is collectively referred to as “warehouse” when there is no need to distinguish between the warehouse and the temporary warehouse. The base information 121 is stored in the storage device provided in the warehouse, or in a server that is connected to the warehouse via a network and stores the base information 121 transmitted from the warehouse. The base information 121 includes warehouse information and inventory information as will be described below. When the base information 121 is stored in the storage device provided in the warehouse, information in a range necessary for a host warehouse, for example, information in a necessary range such as information on the host warehouse and warehouses around the host warehouse may be stored.

The order management unit 130 is stored in a customer's terminal, for example, a smartphone a tablet-type PC, or a personal computer and transmits order information 131 of the customer to the transport planning apparatus 100. The order information 131 is stored in a storage device provided in the terminal, or in a server that is connected to the terminal via a network and stores the order information 131 transmitted from the terminal.

The transport planning apparatus 100 is constituted by an information processing apparatus such as a server. The storage unit 140 receives and stores information transmitted from the vehicle information management unit 110, the warehouse information management unit 120, and the order management unit 130.

Using the information stored in the storage unit 140, the transport plan generating unit 150 makes a transport plan such that a delivery time from the warehouse to a delivery destination becomes shorter and the number of vehicles is reduced. The display unit 160 displays the transport plan, which is generated by the transport plan generating unit 150, on a display device (not illustrated).

The controller 170 transmits the operation instruction information on the vehicle generated by the transport plan generating unit 150 to the vehicle information management unit 110, and transmits the operation instruction information on the temporary warehouse to the warehouse information management unit 120.

The temporary-warehouse installation candidate information 800 relates to information on a candidate site where the temporary warehouse may be located, and a usage status thereof. The information on the candidate site (for example, a place) is data which is previously determined.

### [2. Hardware Configuration System]

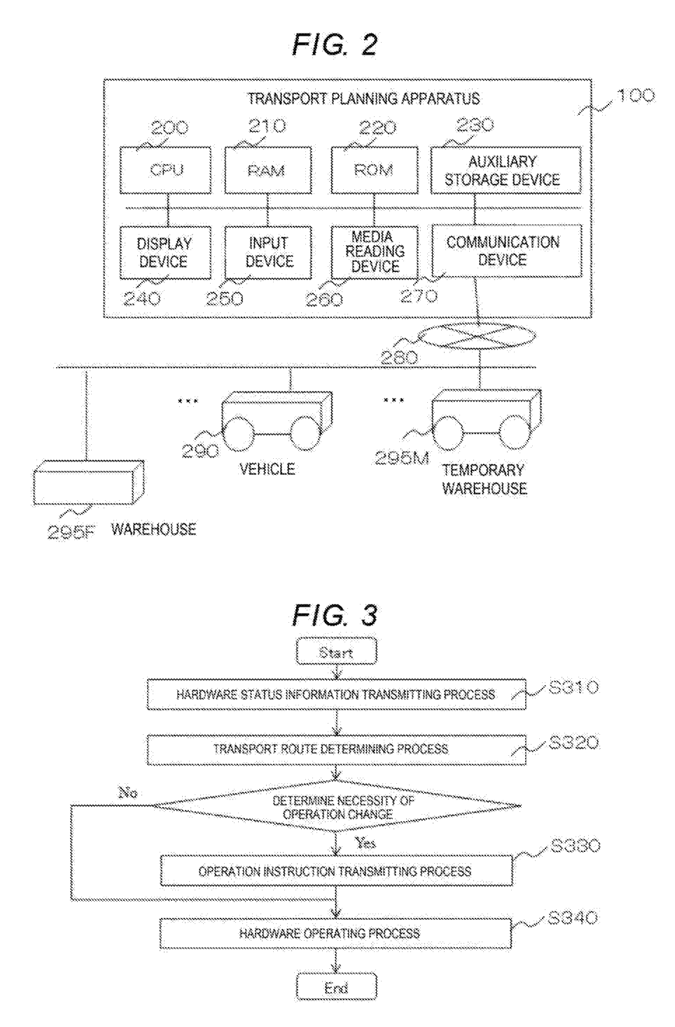

FIG. 2 is an example of a hardware configuration of the system including the transport planning apparatus 100 according to the embodiment. The transport planning apparatus 100 includes a CPU (Central Processing Unit) 200, a RAM (Random access memory) 210, a ROM (Read only memory) 220, an auxiliary storage device 230, a display device 240, an input device 250, media reading device 260, and a communication device 270. The transport planning apparatus 100 can transmit and receive data to and from the vehicle information management unit 110 of a vehicle 290, the warehouse information management unit 120 of a warehouse 295F or a temporary warehouse 295M, and the order management unit 130, via the communication device 270.

In the embodiment, a predetermined function such as calculation or control is realized by the CPU 200 that executes programs stored in the RAM 210, the ROM 220, the auxiliary storage device 230 and the like in the hardware illustrated in FIG. 2. The function or means for realizing the function may be referred to as “function”. “means”, “portion”, “unit”, or “module” for example.

In the embodiment, as a warehouse, the movable temporary warehouse (movable warehouse) 295M is used in addition to the normal warehouse 295F. The temporary warehouse 295M is, for example, a vehicle such as a large-sized trailer, a railroad vehicle, a transport machine, or a cargo ship. In a space (land) where the temporary warehouse 295M is installed, a candidate site is previously determined by the temporary-warehouse installation candidate information 800, and the temporary warehouse 295M is controlled by the instruction from the transport planning apparatus 100 such that the same work as in the normal warehouse 295F is performed in the designated time zone and the candidate site. The candidate site is set as, for example, a parking lot in the case where the temporary warehouse 295M is the trailer, a railroad yard in the case of being the railroad vehicle, and an in-airport in the case of being the transport machine. As described above, when there is no need to distinguish between the warehouse 295F and the temporary warehouse 295M, the warehouse 295 will be described below.

The CPU 200 is a unit for executing various arithmetic operations. The CPU 200 executes various kinds of processing by executing a predetermined transport planning program (not illustrated) loaded on the RAM 210 from the auxiliary storage device 230.

The transport planning program is, for example, an application program executable on an OS (Operating System) program. The transport planning program may be installed in the auxiliary storage device 230 from a portable storage medium via the media reading device 260, for example.

The RAM 210 is a memory which stores programs to be executed by the CPU 200, data necessary for executing programs, and the like. The ROM 220 is a memory which stores programs and the like necessary for activating the transport planning system. The auxiliary storage device 230 is a device such as an HDD (Hard Disk Drive). The auxiliary storage device may be an SSD (Solid State Drive) using a flash memory or the like.

The display device 240 is, for example, a device such as an LCD (Liquid Crystal Display) or organic EL (Electro-Luminescence) display. The input device 250 is, for example, a device such as a keyboard, a mouse, or microphone. The media reading device 260 is a device for reading information of a portable storage medium having portability, for example, a CD-ROM. The communication device 270 inputs/outputs data to and from external devices via a network 230.

The transport planning apparatus 100 acquires the vehicle information 111 from the vehicle 290 via the network 280. In addition, the transport planning apparatus acquires the base information 121 from the warehouse 295.

### [3. Entire Process Flow of Transport Planning Apparatus]

FIG. 3 is an example of a transport plan making process flow for describing the processing of the transport planning apparatus 100 and the hardware. When the transport planning apparatus 100 receives the order information 131 transmitted from the order management unit 130, the transport plan making process is started in the transport plan generating unit 150.

In the transport plan making process, first, (1) a hardware status information transmitting process S310 is performed in which the transport planning apparatus 100 collects status information such as the vehicle information 111 and the base information 121 from the hardware such as the vehicle or warehouse 295 via the network.

Next, (2) a transport route determining process S320 is performed in which the storage unit 140 provided in the transport planning apparatus 100 stores the status information and the transport plan generating unit 150 makes the transport plan. The transport route determining process S320 is also disclosed in PTL 1 as an example, but is generally a process of determining a transport route which minimizes transport costs.

Thereafter, (3) an operation instruction transmitting process S330 is performed in which the controller 170 determines the necessity of the operation change of the hardware such as the vehicle 290 or the temporary warehouse 295M and the controller 170 transmits an operation instruction if the operation change is necessary.

Upon receiving the operation instruction, the vehicle information management unit 110 and the warehouse information management unit 120 perform (4) a hardware operating process S340 of operating the hardware according to the received operation instruction.

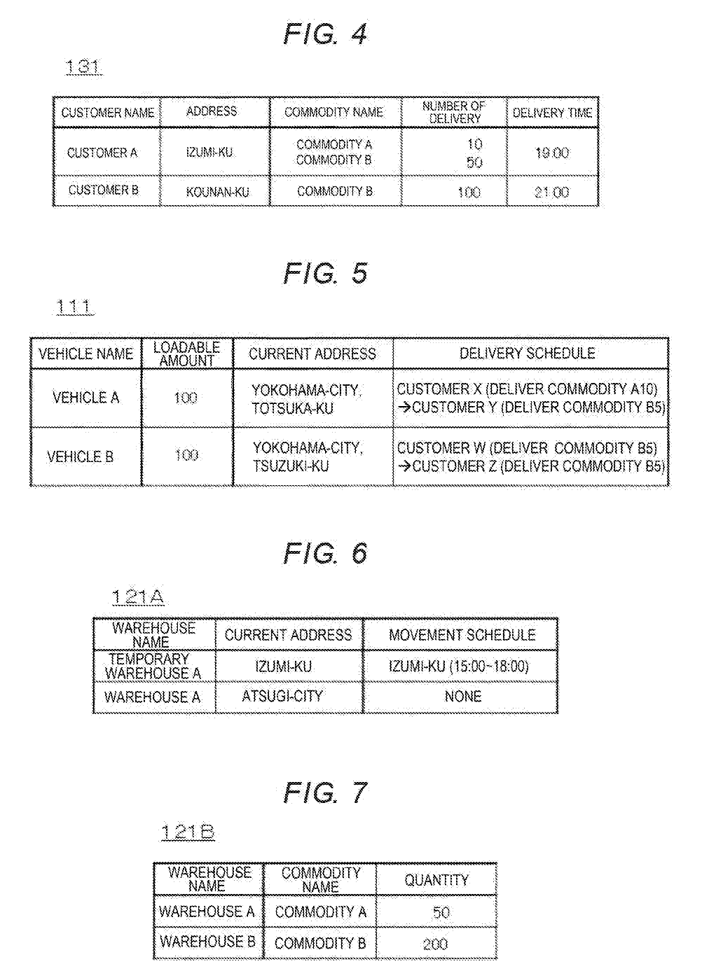

FIG. 4 is an example of the order information 131 of the embodiment. The order information includes at least data items for defining a “customer name” for specifying a customer who gives an order, an “address” which is a delivery destination address, a “commodity name” which is a name of commodity to be delivered, the “number of delivery” which is the number of commodities to be delivered, and a “delivery time” which is a delivery term. In the description, the “name” includes identification information such as an ID for uniquely specifying a target and other symbols. Further, the “address” described in the description includes general information that specifies coordinates and other positions.

The processes (1) to (4) illustrated in FIG. 3 will be described below.

[4. Process flow (hardware status information transmitting process) of transport planning apparatus]

(1) Hardware status information transmitting process S310.

In the hardware status information transmitting process S310 illustrated in FIG. 3, the vehicle information management unit 110 mounted on the vehicle 290 transmits the vehicle information 111 to the storage unit 140 of the transport planning apparatus 100 via the network 280, based on the instruction of the transport planning apparatus 100. Further, the warehouse information management unit 120 installed in the warehouse 295 transmits the warehouse information and the inventory information included in the base information 121 to the storage unit 140 via the network 280.

FIG. 5 is an example of the vehicle information 111 of the embodiment. The vehicle information includes at least data items for defining a “vehicle name” for identifying the vehicle 290, a “loadable amount” which is a loadable amount of the vehicle, a “current address” which is an address of a place where the vehicle exists at the time of information transmission, and a “delivery schedule” indicating a delivery amount for each customer scheduled to be delivered by the vehicle after information transmission.

FIG. 6 is an example of warehouse information 121A of the embodiment. The warehouse information 121A includes at least data items for defining a “warehouse name” for identifying the warehouse, a “current address” which is an address of a place where the warehouse exists at the time of information transmission, and a “movement schedule” which is a movement schedule after information transmission of the warehouse. The item “movement schedule” is an item unique to the temporary warehouse 295M, and the normal warehouse. 295F not moving does not have such data item. Further, the item “current address” is variable data in the temporary warehouse 295M, but is fixed data in the normal warehouse 295F which does not move.

FIG. 7 is an example of inventory information 121B of the embodiment. The inventory information 121B includes at least data items for defining a “warehouse name”, a “commodity name” which is a name of a commodity stored in the warehouse, and a “quantity” which is a quantity of commodities being stored. In the embodiment, the inventory information 121B is data relating to the normal warehouse 295F, but may include inventory data of the temporary warehouse 295M.

The storage unit 140 of the transport planning apparatus 100 reads the temporary-warehouse installation candidate information 800 after reading the vehicle information 111, the warehouse information 121A, and the inventory information 121B.

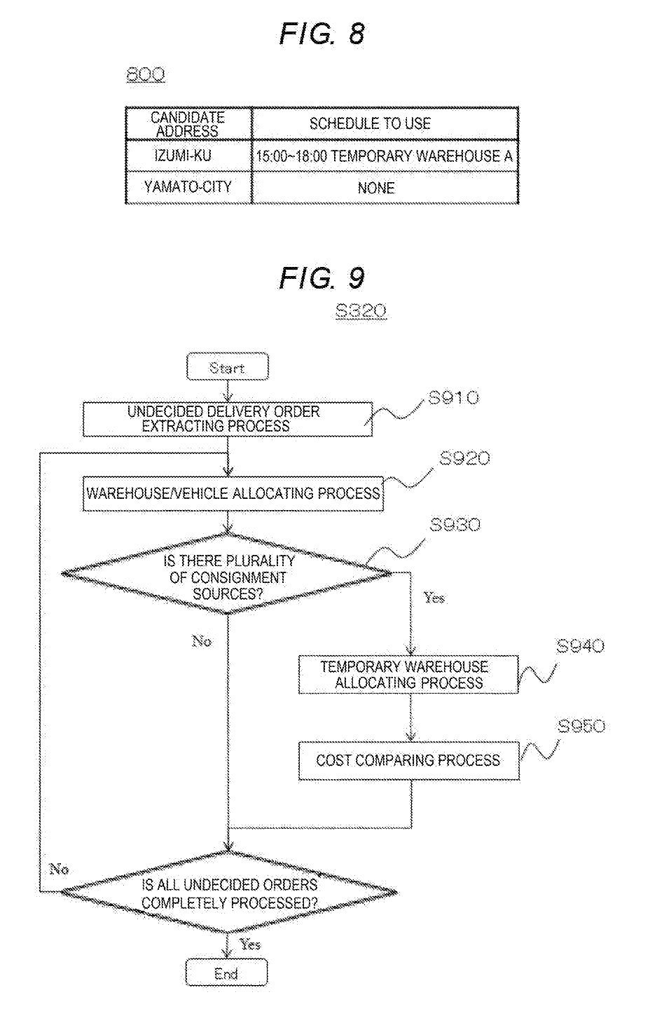

FIG. 8 is an example of the temporary-warehouse installation candidate information 800 of the embodiment. The temporary-warehouse installation candidate information 800 includes at least data items for defining a “candidate address” which is an address of a place where a temporary warehouse can be installed, a “schedule to use” which is an installation schedule of the temporary warehouse at the address after information transmission. The “candidate address”, which is the address of the place where the temporary warehouse can be installed, is previously determined.

### [5. Process Flow (Transport Route Determining Process) of Transport Planning Apparatus]

(2) Transport Route Determining Process S320

In the transport route determining process S320 illustrated in FIG. 3, the RAM 210 in the storage unit 140 stores the order information 131 transmitted by the order management unit 130, the vehicle information 111 transmitted by the vehicle information management unit 110, and the warehouse information 121A and the inventory information 121B transmitted by the warehouse information management unit 120. The transport plan generating unit 150 determines a transport route using the information stored in the storage unit 140.

FIG. 9 illustrates a flow of the transport route determining process S320. In the transport route to determining process, first, an undecided delivery order extracting process S910 is performed. In the undecided delivery order extracting process S910, the fact is confirmed that there is description in the delivery schedule of the vehicle information 111 with respect to each record of the order information 131, and the records of the order information, in which the description is not given to the delivery schedule, are extracted.

Next, one record is selected from the orders in which the description is not given to the delivery schedule and a warehouse/vehicle allocating process S920 is performed on the selected order. In the warehouse/vehicle allocating process S920, the inventory information 121B is searched to specify the warehouse 295F keeping the commodity included in the order, and the specified warehouse allocated as a commodity transport source of the order.

In addition, the delivery schedule of the vehicle information 111 is searched to specify a vehicle, which is scheduled to be delivered to the customer closest to the address of the order, among vehicles on which the order can be loaded, and the specified vehicle is allocated to the order. The warehouse/vehicle allocating process S920 described above may follow the technique disclosed in PTL 1.

Next, in a consignment source determining process S930, it is determined whether there are a plurality of warehouses 295F as the commodity transport sources allocated to the order. When there are the plurality of warehouses, subsequently, the temporary warehouse allocating process S940 is performed. When there is one warehouse, the transport plan is decided for delivery of the order with the warehouse and vehicle allocated in the warehouse/vehicle allocating process S920, and the next record of the order information is processed.

The temporary warehouse allocating process S940 is performed in the case where there are the plurality of warehouses 295F as the commodity transport sources allocated to the order. The center point of gravity of the warehouse 295F as the commodity transport source allocated to the order is calculated, and the temporary-warehouse installation candidate information 800 is searched to specify a temporary warehouse installation candidate closest to the center point of gravity. The schedule to use the temporary warehouse installation candidate is confirmed, and it is assumed that the temporary warehouse 295M is installed at the address of the temporary warehouse installation candidate when there is no schedule to use before the delivery time of the order.

Next, the warehouse information 121A is searched to specify the temporary warehouse 295M that can be moved to the set temporary warehouse installation candidate address before the delivery time of the order. When there is a corresponding temporary warehouse 295M, such a temporary warehouse is used, and the temporary warehouse 295M is moved to the temporary warehouse installation candidate address.

In the case of using the temporary warehouse 295M, a delivery vehicle from the warehouse 295F as the commodity transport source to the temporary warehouse 295M is determined. The delivery schedule of the vehicle information 111 is searched, and when the quantity of the order can be loaded on a vehicle existing near the warehouse 295F as the commodity transport source, the vehicle is determined as a vehicle to be delivered from the warehouse 295F to the temporary warehouse 295M. When there is no such a vehicle, the vehicle to be delivered from the temporary warehouse 295M to the delivery destination is determined as to be delivered from the warehouse to the delivery destination. In this way, a transport plan in the case where the temporary warehouse is used is formulated.

The transport plan generation in the temporary warehouse allocating process S940 described above may follow, for example, the technique disclosed in PTL 1, except that a virtual temporary warehouse is used. Further, the temporary warehouse 295M needs to arrive at the time the commodities arrive from the warehouse 295F, but this can be considered in the same way as the scheduling of the time-designated commodity delivery.

As described above, when there are a plurality of delivery sources of commodities, two types of transport plans are generated, one type being in a case where the temporary warehouse is not used and the other type being in a case where the temporary warehouse is used.

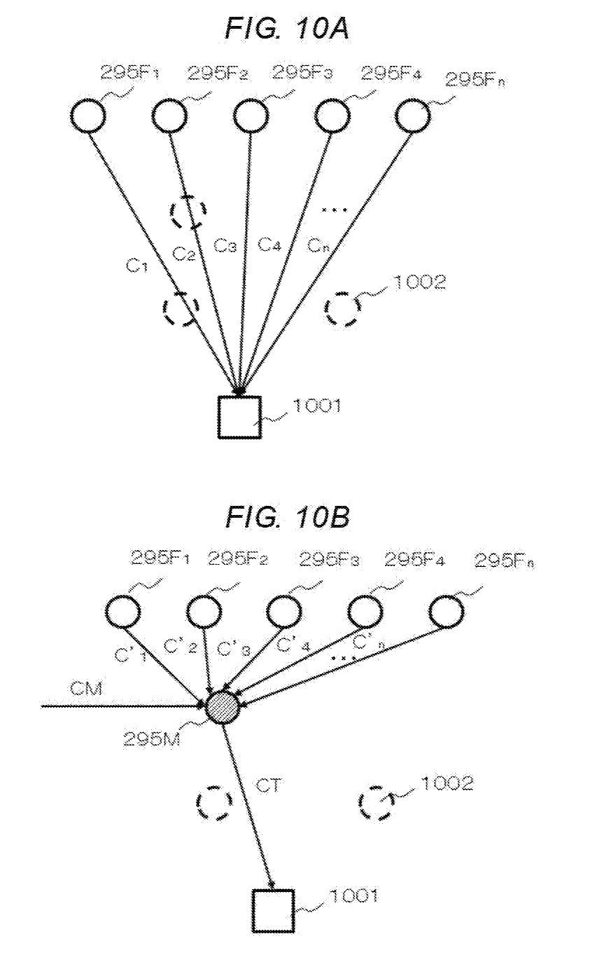

FIG. 10A illustrates a conceptual diagram of the transport plan in the case where the temporary warehouse is not used. In addition, FIG. 10B illustrates the transport plan in the case where the temporary warehouse is used.

FIG. 10A illustrates an example of a transport plan from n warehouses 295F as a delivery source to a transport destination 1001. In this case, for example, n carriers will delivered from the n warehouses 295F to the transport destination 1001.

FIG. 10B illustrates the case where the temporary warehouse is used, the temporary warehouse 295M is installed in a place close to the center position of gravity of n warehouses 295F among temporary warehouse installation candidate addresses 1002 extracted based on the temporary-warehouse installation candidate information 800. In this example, n carriers are delivered from the n warehouses 295F to the temporary warehouse 295M, and one carrier is delivered from the temporary warehouse 295M to the transport destination 1001.

After two transport plans are created, a transport cost comparing process S950 of the two transport plans is performed. The concept of the delivery cost can also be found in PTL 1, but the delivery cost can be estimated by, for example, a total traveling distance of the delivery vehicle related to the transport and a total occupancy time. As a result of the comparison, a transport plan with a low transport cost is set as a final transport plan, and a next process of checking the presence or absence of the unprocessed order S960 is performed.

In FIG. 10A, assuming that costs necessary for delivering the n carriers from the n warehouses 295F to the temporary warehouse 295M are defined as C₁ to Cₙ, respectively, a total transport cost to the transport destination 1001 is the sum ΣCₙ of C₁ to Cₙ.

In FIG. 10B, assuming that costs necessary for delivery the n carriers from the n warehouses 295F to the temporary warehouse 295M are defined as C′₁ to C′ₙ, a cost necessary for the delivery from the temporary warehouse 295M to the transport destination 1001 is defined as CT, and a cost necessary for setting up the temporary warehouse 295M is defined as CM, a total transport cost to the transport destination 1001 is the sum ΣC′ₙ+CT+CM of C′₁ to C′ₙ.

By comparison of these costs, a transport plan with a low cost is adopted. As described above, the commodity carrying warehouse, the vehicle to be delivered from the warehouse, the temporary warehouse which is a passage route as necessary, and the vehicle to be delivered from the warehouse to the temporary warehouse are determined, and a transport route is created. The warehouse/vehicle allocating process

S920 and the temporary warehouse allocating process S940 as necessary are performed on all the order information extracted in the undecided delivery order extracting process S910, and thus the transport route is decided for all orders. The decided transport route is stored in the storage unit 140 as transport plan information.

In the above embodiment, the temporary warehouse installation candidate address 1002 near the center of gravity of the delivery source, which is assumed to be geometrically low in the transport cost, is selected. As another method, the temporary warehouse installation candidate address 1002 may be selected from a positional relation between the delivery source and the delivery destination. For example, the delivery source and the delivery destination are connected to each other with a straight line, and a temporary warehouse installation candidate address 1002 having the smallest sum of distances from the straight line is selected. Further, a temporary warehouse installation candidate address 1002 having the smallest sum of moving distances from the delivery source is selected using map information.

A plurality of temporary warehouse installation candidate addresses 1002 may be selected. In that case, for each of the plurality of temporary warehouse 295M, a transport plan may be created in the case of using the temporary warehouse, and a transport plan with the lowest transport cost may be selected.

In the embodiment when there are a plurality of warehouses as consignment sources, the transport plans are respectively made in the case of using and not using the temporary warehouse and the costs are compared. However, when the cost necessary for setting up the temporary warehouse can be estimated sufficiently low, the cost comparing process may be omitted, and when there are a plurality of warehouses as consignment sources, the temporary warehouse may be always used. Therefore, in this case, it is not necessary to make a transport plan in the case of not using the temporary warehouse.

### [6. Process Flow (Transport Plan Information and Display) of Transport Planning Apparatus]

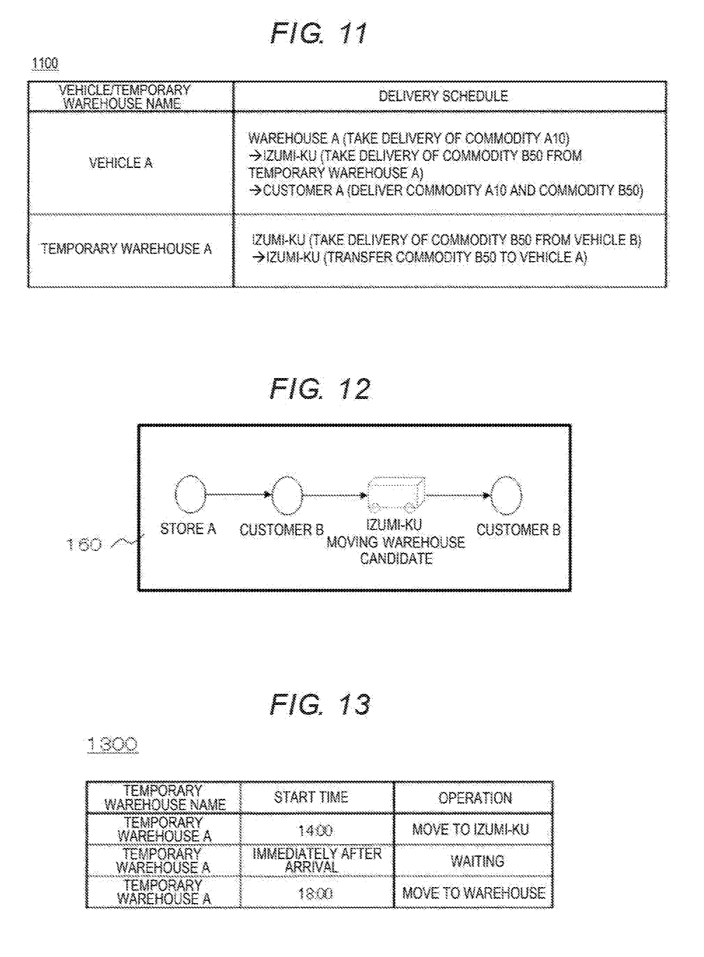

FIG. 11 is an example of transport plan information 1100 of the embodiment. The transport plan information includes at least data items for defining a “vehicle/temporary warehouse name” which is a name of the vehicle 290 or the temporary warehouse 295M and a “delivery schedule” representing the delivery destination, the delivery commodity name, and the delivery quantity of the vehicle 290 or the temporary warehouse 295M. After the transport route determination, the display unit 160 displays the transport route.

FIG. 12 is an example in which the transport route of the vehicle 290 is displayed on the display unit 160. The delivery destination or the warehouse is displayed as a flow in the order of the delivery schedule of the transport plan information of the vehicle 290. In addition to the displayed screen, each time is designated and an address where each vehicle and each temporary warehouse exist at the designated time may be displayed on a map. Further, the quantity of commodities included in each vehicle and temporary warehouse may be displayed. A planner of the transport plan can grasp movement of each vehicle and temporary warehouse by confirming the quantity of commodities.

### [7. Process Flow (Operation Instruction Transmitting Process, of Transport Planning Apparatus]

(3) Operation Instruction Transmitting Process S330

When the transport plan is performed and the transport route determining process S320 is completed, the transport planning apparatus 100 instructs the operation of the vehicle 290 and the temporary warehouse 295M necessary for executing the transport plan. That is, the predetermined vehicle 290 and the temporary warehouse 295M are instructed to move to a predetermined place at a predetermined time. The vehicle 290 and the temporary warehouse 295M, which do not require movement to execute the transport plan, are not instructed to move.

In the operation instruction transmitting process S330 illustrated in FIG. 3, the controller 170 takes out an operation start time and an operation for each of the vehicle 290 and the temporary warehouse 295M included in the transport plan information 1100, and creates operation instruction information of the vehicle 290 and operation instruction information of the temporary warehouse 295M. The created operation instruction information is transmitted to the respective vehicles 290 and temporary warehouses 290 via the network 280.

FIG. 13 is an example of operation instruction information 1300 of the temporary warehouse of the embodiment. The operation instruction information of the temporary warehouse includes data items for defining a “temporary warehouse name”, a “start time” that is a time at which the temporary warehouse starts to operate, and an “operation” of the temporary warehouse indicating an operation that starts from the start time.

### [8. Hardware Operating Process]

(4) Hardware Operating Process S340

In the hardware operating process S340 illustrated in FIG. 3, the process is performed in the vehicle 290 and the temporary warehouse 295M that receive the operation instruction information. Upon receiving the operation instruction information of the vehicle., the vehicle information management unit 110 transmits or displays an instruction to the driver of the vehicle 290 so as to operate the vehicle immediately after the start time according to the received operation instruction. Upon receiving the operation instruction information of the temporary warehouse 295M, the warehouse information management unit 120 transmits or displays an instruction to the driver of the temporary warehouse 295M so as to operate the temporary warehouse 295M immediately after the start time according to received operation instruction. An arrival time of the temporary warehouse 295M to the temporary warehouse installation candidate address 1002 is earlier than a departure time of the vehicle from the temporary warehouse installation candidate address 1002 to the transport destination 1001.

Thus, the vehicle and the temporary warehouse can be operated according to the transport plan, the load factor of the vehicle is improved, and the number of vehicles is reduced, whereby there is an effect of eliminating the insufficiency of the driver of the vehicle while satisfying the customer's request with a short delivery time.

### Second Embodiment

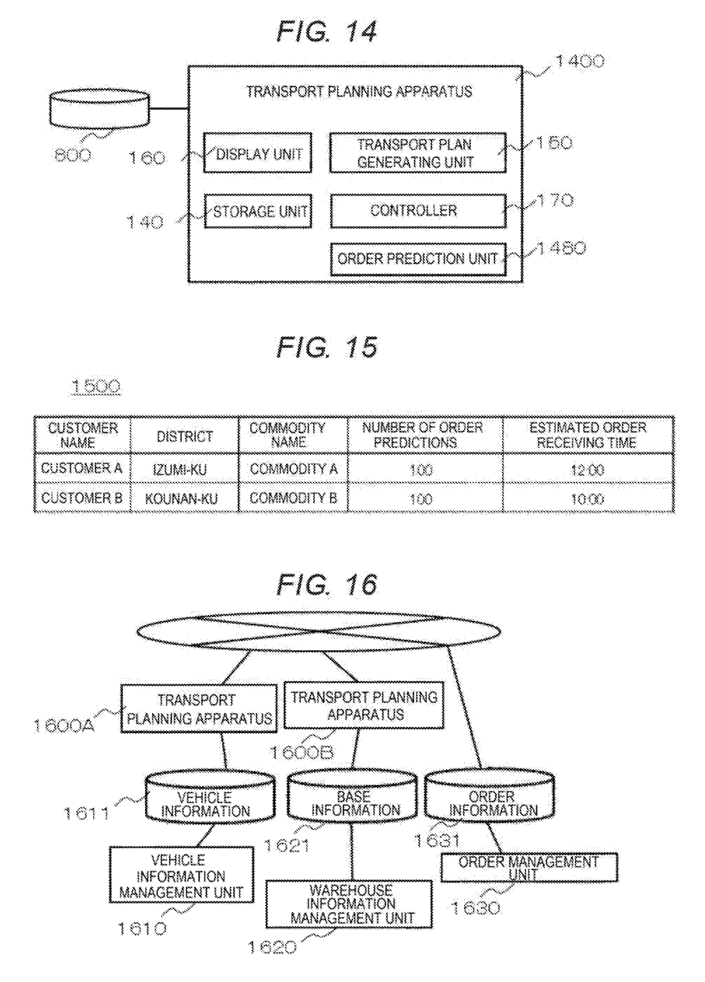

Next, a second embodiment will be described in a case of including order prediction information. In the second embodiment, the transport planning apparatus 100 included in the transport planning system of the first embodiment is replaced by a transport planning apparatus 1400 illustrated in FIG. 14.

FIG. 14 is a block diagram illustrating the transport planning apparatus 1400 of the second embodiment. The same reference numerals are given to the same components as those of the transport planning apparatus 100 and a description thereof will not be presented. The transport planning apparatus 1400 includes an order prediction unit 1480 in addition to the configuration of the transport planning apparatus 100 according to the first embodiment. Upon receiving the order information, the order prediction unit 1480 analyzes the tendency of the order information so far and predicts a future order quantity.

FIG. 15 is an example of order prediction information. Order prediction information 1500 includes, for example, a customer name, a district, a commodity name, the number of order predictions, and an estimated order receiving time.

A transport plan making process flow of a second embodiment follows the process flow illustrated in FIG. 3. However, the order prediction information 1500 is used in the transport route determining process S320.

In the transport route determining process S320, each of records of the order prediction information as well as the undecided delivery order is also extracted as an object of the process subsequent to the process S920 in the undecided delivery order extracting process S910. In the warehouse/vehicle allocating process S920, warehouse/vehicle allocation is determined so as to depart from the warehouse after exceeding the estimated order receiving time of the record with respect to each record of the order prediction information.

When the warehouse/vehicle allocation is performed including the order prediction information 1500, the delivery can be performed in a short time even when the demand amount changes, compared with the case of not including the order prediction information.

### Third Embodiment

Finally, a third embodiment will be described in which the transport planning apparatus is mounted in a vehicle and a warehouse. In the first embodiment, for example, the transport planning apparatus 100 is described as a system which is disposed in a control center for controlling the all configuration, aggregates necessary information, distributes necessary instructions to the vehicle 290, the warehouse 295F, and the temporary warehouse 295M, and operates the vehicle and the warehouse according to the instruction. In the third embodiment, an example is described in which the transport planning apparatus is mounted in each vehicle and warehouse to perform the process in a distributed manner.

FIG. 16 is a block diagram of a system of the third embodiment. A transport planning apparatus 1600 is mounted (or accessible) in each warehouse and each vehicle. A transport planning apparatus 1600A mounted in the vehicle can use vehicle information 1611 and resources of a vehicle information management unit 1610. A transport planning apparatus 1600B mounted in the warehouse can use base information 1621 and resources of a warehouse information management unit 1620. Further, each transport planning apparatus 1600 can communicate with an order management unit 1630, and can receive order information 1631.

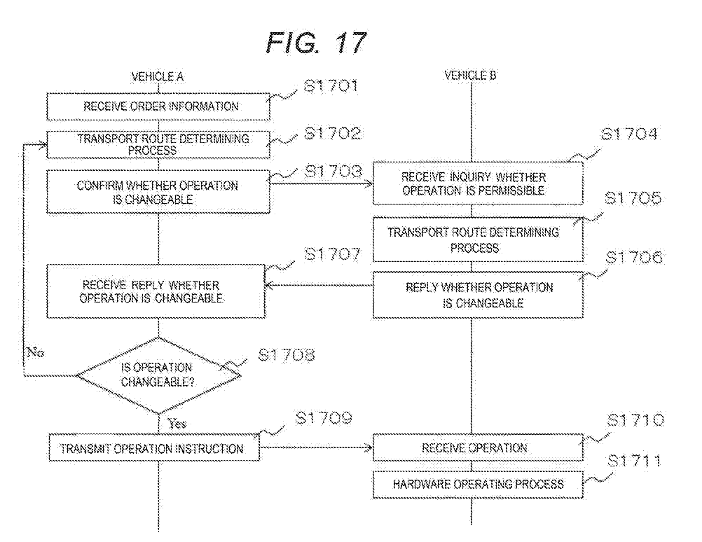

Using FIG. 17, the operation of the system in FIG. 16 will be described. In this example, a transport planning apparatus mounted in a vehicle and a transport planning apparatus mounted in a vehicle B respectively create transport plans, and operate by mutual plan adjustment. Therefore, the subject of the operation in FIG. 17 is the transport planning apparatus of each vehicle.

In the embodiment, each vehicle independently receives the order information, and independently makes the transport plan. As the vehicle A receives the order information, the process starts in the vehicle A (S1701). The vehicle A performs a transport route determining process based on the order information (S1702). This process is equivalent to the process S320 (see FIG. 9) illustrated in FIG. 3. Information necessary for the process is obtained via the network 500. At this time, the range of information to be processed may be limited in order to compress the amount to be processed. For example, the process is performed by being limited to information of a vehicle or a warehouse within a predetermined range centering on the host vehicle.

Upon receiving the order information 1631 and receiving an order of the customer, each transport planning apparatus 1600 makes a transport plan to deliver the order to the delivery destination using the vehicle or the warehouse. The formulated plan is transmitted to the transport planning apparatus 1600 of another vehicle, and when a delivery cost of the vehicle is lower than that of another vehicle, the transport plan of the vehicle is decided.

When the delivery cost of another vehicle is low, the transport plan of the vehicle is discarded. When the transport plan decided, the transport plan of the vehicle is transmitted to the warehouse as a consignment source of luggage. The warehouse, which has received the transport plan, confirms that the commodity can be prepared until the departure time of the transport plan, and replies to the vehicle that the commodity can be prepared. When the commodity can hardly be prepared, the earliest preparable time is replied. In the vehicle receiving the reply, the departure time is changed to a preparable time and a transport plan is made again when the commodity can hardly be prepared.

As described above, each of the vehicle and the warehouse autonomously makes the transport plan, so that the transport plan can be quickly made even when the number of vehicles and the number of warehouses become large.

The description will be made assuming that the cost of the transport plan of the vehicle A is lowest in FIG. 17. The vehicle A performs the temporary warehouse allocating process and the like according to the process S320 described in FIG. 9. In the first embodiment, the result of the process S320 is intactly instructed to operate each vehicle, and the operation may be executed (the processes S330 to S340 in FIG. 3). In the third embodiment, however, there is a possibility that the instructed operation can hardly be performed on the vehicle receiving the instruction due to its own transport plan.

In the embodiment, therefore, subsequently, whether the operation is changeable is confirmed (S1703). That is, since the control of the operation change is unified in the first embodiment, the operation is simply changed by the instruction but since the control of the operation change is not unified in the second embodiment, when the operation change is necessary, the change target vehicle receives an inquiry whether the changed operation is permissible (S1704). For example, when the vehicle A is 295F₁ in FIG. 10A or FIG. 10B in the case of changing from the operation in FIG. 10A to the operation in FIG. 10B, the operation change of 295F₂ to 295Fₙ should be requested. Suppose that the 295F₂ is the vehicle B. At this time, since the vehicle B also independently receives the order information and performs the transport route determining process, the operation of the vehicle B can hardly be changed when the change in the operation from the vehicle A conflicts with the own plan. Accordingly, when the vehicle B receives inquiry whether the operation is permissible (S1704), it is determined by the transport route determining process whether the operation is changeable (S1705). There may be various determination methods, but for example, a schedule determined in advance may be prioritized.

When the operation is changeable, a transport route according to the operation change from the vehicle A is determined, and the vehicle A receives a reply that the change is possible. When the operation is not changeable, the vehicle A receives a reply that the change is impossible (S1706 to S1707).

When the vehicle A receives the reply that the operation is changeable (YES in S1708), the vehicle B is instructed to execute the operation (S1709), and the vehicle B receiving such an instruction performs the hardware operating process (S1710 to S1711). When the vehicle A receives the reply that the operation is not changeable (NO in S1708), the transport route determining process is performed again under the condition that the vehicle B is not used (S1702). In this manner, similar inquiries and confirmations are also performed on other related vehicles, so that the same effect as in the first embodiment can be achieved by distributed processing.

Further, the invention is not limited to the above embodiments, and includes various modifications. For example, the above embodiments have been described in detail for easy understanding on the invention. The invention is not necessarily limited to a configuration provided with all the described components. In addition, some of the configurations of a certain embodiment may be replaced with those of the other embodiments, and the configurations of the other embodiments may be added to those of one embodiment. In addition, some of the configurations of each embodiment may be added, omitted, replaced with other configurations.

In addition, some or all of the respective configurations, functions, processing units, and processing means may be realized in hardware by an integrated circuit for example. In addition, the respective configurations and functions may be realized in software such that the processor analyzes programs for realizing the respective functions and executes the programs.

In addition, the control lines and the information lines considered as necessary in explanation are illustrated, and it does not mean that all the control and the information lines necessary in manufacturing are illustrated. Almost all the configurations are actually connected to each other.

These embodiments can provide the transport planning system that increases the delivery frequency without lowering the load factor of each vehicle even when the reduction in the delivery efficiency of each vehicle is concerned. Therefore, it is possible to make the transport plan that improves the loading efficiency of the vehicle and shortens the delivery time from the warehouse to the delivery destination, whereby there is an effect of eliminating the insufficiency of the driver of the vehicle while satisfying the customer's request with a short delivery time.

The invention is not limited to the above examples, and includes various modifications. For example, some of the configurations of a certain example may be replaced with those of the other examples, and the configurations of the other examples may be added to those of the subject example. In addition, some of the configurations of each example may be added, omitted, replaced with other configurations.

### REFERENCE SIGNS LIST

100: transport planning apparatus

110: vehicle information management unit

120: warehouse information management unit

130: order management unit

1. A transport plan generating method using an information processing apparatus including an input device, a processor, and an output device,
from the input device, the information processing apparatus being capable of acquiring:
order information including, a customer address that specifies a position of a transport destination and a commodity name that specifies a commodity to be transported;
vehicle information including a vehicle name that specifies a vehicle and current address information that specifies a current address of the vehicle;
warehouse information including a warehouse name that specifies a warehouse, in which the commodity is stored, and warehouse address information that specifies a current address of the warehouse;
inventory information including information on the commodity stored in the warehouse corresponding to the warehouse name; and
temporary-warehouse installation candidate information including information on a candidate site where there is a possibility that a movable temporary warehouse is disposed among the warehouses,
the method comprising:
executing, using the processor, processes of
receiving the order information,
receiving the vehicle information,
receiving the warehouse information and the inventory information, and
generating a first transport plan including plans to specify the warehouse as a commodity transport source and a vehicle transporting the commodity, based on the order information, the vehicle information, the warehouse information, and the inventory information, to set at least one selected from the candidate sites as a gathering area, and to transport the commodity from the transport source to the gathering area with the vehicle transporting the commodity; and
issuing an instruction based on the first transport plan to at least one of the vehicle and the temporary warehouse from the output device.

2. The transport plan generating method according to claim 1, wherein
the first transport plan includes a plan to transport the commodity from the gathering area to the transport destination with at least one of the vehicles.

3. The transport plan generating method according to claim 1, wherein
the first transport plan includes a plan to move the temporary warehouse to the gathering area.

4. The transport plan generating method according to claim 1, further comprising:
executing a process of generating a second transport plan including plans to specify the warehouse as a commodity transport source and a vehicle transporting the commodity, based on the order information, the vehicle information, the warehouse information, and the inventory information and to transport, regardless of the gathering area, the commodity from the transport source to the transport destination with the vehicle transporting the commodities; and
comparing a cost of the first transport plan with a cost of the second transport plan to adopt a transport plan with a low cost.

5. The transport plan generating method according to claim 1, further comprising:
executing the process of generating the first transport plan when there are the plurality of warehouses as commodity transport sources; and
executing a process of generating a second transport plan including plans to specify the warehouse as a commodity transport source and a vehicle transporting the commodity, based on the order information, the vehicle information, the warehouse information, and the inventory information and to transport, regardless of the gathering area, the commodity from the transport source to the transport destination with the vehicle transporting the commodities, instead of the process of generating the first transport plan when the warehouse is single as the commodity transport source.

6. The transport plan generating method according to claim 1, wherein
the warehouse information enables to distinguish the temporary warehouse from warehouses which are not the temporary warehouse, and
the warehouse information includes information on a movement schedule of the temporary warehouse.

7. The transport plan generating method according to claim 1, wherein
the temporary-warehouse installation candidate information includes information on an address of the candidate site and a schedule to use the candidate site.

8. The transport plan generating method according to claim 1, further comprising:
executing a process of generating a second transport plan including plans to specify the warehouse as a commodity transport source and a vehicle transporting the commodity, based on the order information, the vehicle information, the warehouse information, and the inventory information and to transport, regardless of the gathering area, the commodity from the transport source to the transport destination with the vehicle transporting the commodities; and
based on the second transport plan, generating operation instruction information of the temporary warehouse having data items for defining a start time that is a time at which the temporary warehouse starts to operate and an operation of the temporary warehouse indicating an operation that starts from the start time, corresponding to a temporary warehouse name for specifying the temporary warehouse.

9. The transport plan generating method according to claim 1, wherein
the temporary warehouse is at least one selected from a vehicle, a railroad vehicle, a transport machine, and a cargo ship.

10. A transport plan generating system including an information processing apparatus which is capable of using:
order information including transport destination position information that specifies a position of a transport destination and object information that specifies an object to be transported;
transport unit information including transport unit identification information that specifies a transport unit and current transport unit position information that specifies a current position of the transport unit;
stationary warehouse information including stationary warehouse identification information that specifies a stationary warehouse which does not move and stores the object and stationary warehouse position information that specifies a position of the stationary warehouse;
inventory information including information on the object stored in the stationary warehouse corresponding to the stationary warehouse identification information;
temporary warehouse information including temporary warehouse identification information that specifies a temporary warehouse which is movable and stores the object and temporary warehouse position information that specifies a position of the temporary warehouse; and
temporary-warehouse installation candidate information that specifies a position of a candidate site in which the temporary warehouse is settable up,
the system comprising:
a transport plan generating unit that generates a first transport plan, based on the order information, the transport unit information, the stationary warehouse information, the inventory information, the temporary warehouse information, and the temporary-warehouse installation candidate information, wherein
the first transport plan is to transport the object from transport sources, which are a plurality of stationary warehouses selected from the stationary warehouses, to the transport destination via at least one of the candidate sites.

11. The transport plan generating system according to claim 10, wherein
the first transport plan includes a temporary warehouse setting-up plan to move at least one temporary warehouse selected from the temporary warehouses to at least one of the candidate sites, and
the temporary warehouse setting-up plan is generated based on the temporary warehouse information and the temporary-warehouse installation candidate information.

12. The transport plan generating system according to claim 10, wherein
the transport plan generating unit generates a second transport plan to transport the object from a transport source, which is at least one stationary warehouse selected from the stationary warehouses, to the transport destination directly.

13. The transport plan generating system according to claim 12, wherein
the first transport plan and the second transport plan are compared in cost with each other to adopt a transport plan with a low cost, and at least one of the transport unit and the temporary warehouse is instructed to operate based on the adopted transport plan.

14. The transport plan generating system according to claim 12, wherein
the first transport plan is adopted when there are the plurality of transport sources, the second transport plan is adopted when the transport source is single, and at least one of the transport unit and the temporary warehouse instructed to operate based on the adopted transport plan.

15. The transport plan generating system according to claim 10, wherein
the first transport plan includes:
a temporary warehouse setting-up plan to move at least one temporary warehouse selected from the temporary warehouses to at least one of the candidate sites; and
a delivery plan to move at least one transport unit selected from the transport units from the candidate site, to which the temporary warehouse is moved, to the transport destination, and
an arrival time of the temporary warehouse to the candidate site is earlier than a departure time of the transport unit from the candidate site to the transport destination.

16. The transport plan generating system according to claim 10, wherein
the transport plan generating system predicts a future order prediction amount from a past order result to generate order prediction information including prediction transport destination position information that specifies a position of a predicted transport destination and prediction object information that specifies a transport object to be predicted, and to generate the first transport plan using the order prediction information.

17. The transport plan generating system according to claim 16, wherein
the order prediction information includes an estimated order receiving time, and the first transport plan is generated so as to depart the stationary warehouse after the estimated order receiving time.

18. The transport plan generating system according to claim 10, wherein
at least one of the vehicle, the stationary warehouse, and the temporary warehouse independently generates the first transport plan.

19. A transport plan generating method using an information processing apparatus including an input device, a processor, and an output device, the method comprising:
generating a delivery route of a commodity by a delivery unit from a forwarding source to a forwarding destination;
assuming a moving warehouse that is temporarily installed and movable when there are the plurality of forwarding sources;
changing the delivery route so that the commodity is delivered to the forwarding destination via the moving warehouse; and
generating a movement instruction with respect to the delivery unit and the moving warehouse so as to realize the changed delivery route.

20. The transport plan generating method according to claim 19, wherein
the information processing apparatus is either a server connected to the delivery unit via a network or a server mounted on the delivery unit and moving together with the delivery unit.
